(19) United States
(12) Patent Application Publication
(10) Pub. No.: US 2013/0128747 A1
(43) Pub. Date: May 23, 2013

(54) SYSTEM, METHOD AND PROGRAM PRODUCT FOR NETWORK DATA FLOW MEASUREMENT

(71) Applicants: Ido Feldman, Tel Aviv (IL); Amir Fish, San Francisco, CA (US)

(72) Inventors: Ido Feldman, Tel Aviv (IL); Amir Fish, San Francisco, CA (US)

(21) Appl. No.: 13/679,701

(22) Filed: Nov. 16, 2012

(30) Foreign Application Priority Data
Nov. 17, 2011 (IL) 216416

(51) Int. Cl. H04L 12/26

(52) U.S. Cl. CPC H04L 43/04
USPC 370/241

(57) ABSTRACT

Implementations of a method, program product and system are disclosed for network data flow measurement. In implementations, the method comprises steps of receiving, by one or more computers and a network link, network traffic sampling data through the network link, and obtaining, using the one or more computers, bandwidth data carried on the network link. A further step is provided of determining a scaling factor, using the one or more computers, based at least in part on a comparison of the bandwidth data through the network link and the network traffic sampling data through the network link. The network traffic sampling data is scaled, using the one or more computers, based at least in part on the scaling factor to obtain scaled network traffic sampling data. This scaled network traffic sampling data may be communicated electronically.

### CROSS REFERENCE TO RELATED APPLICATION

This application claims priority to Israeli Patent Application No. 216416, entitled “System, Method And Program Product For Network Data Flow Measurement,” filed on Nov. 17, 2011. The contents of this application are incorporated herein by reference.

### BACKGROUND OF THE INVENTION

Problems have arisen in obtaining IP traffic information for a network, when using for the network monitoring an unreliable Internet protocol that is prone to data loss. This can lead to substantial inaccuracy of the IP traffic level estimate.

### SUMMARY OF THE INVENTION

In implementations of the inventions, a method and program product are disclosed for network data flow measurement. In implementations, steps are provided of receiving, by one or more computers and a network link, network traffic sampling data through the network link, and obtaining, using the one or more computers, bandwidth data carried on the network link. A further step is provided of determining a scaling factor, using the one or more computers, based at least in part on a comparison of the bandwidth data through the network link and the network traffic sampling data through the network link. The network traffic sampling data is scaled, using the one or more computers, based at least in part on the scaling factor to obtain scaled network traffic sampling data. This scaled network traffic sampling data may be communicated electronically.

In implementations, a system is disclosed for network data flow measurement, comprising: a network connection; and one or more computers, operably connected to the network connection, the one or more computers configured to receive network traffic sampling data through the network link and to obtain bandwidth data carried on the network link. The one or more computers are further configured to determine a scaling factor based at least in part on a comparison of the bandwidth data through the network link and the network traffic sampling data through the network link and to scale the network traffic sampling data based at least in part on the scaling factor to obtain scaled network traffic sampling data. The system may further comprise a transmitter configured to electronically communicate the scaled network traffic sampling data.

In implementations, a method is disclosed for network data flow measurement, comprising the steps of receiving, by one or more computers and a network link, network traffic sampling data comprising Netflow data or SFlow data through the network link, and obtaining, using the one or more computers, bandwidth data comprising simple network management protocol (SNMP) data carried on the network link Implementations of the method may further comprise determining a scaling factor, using the one or more computers, based at least in part on a comparison of the bandwidth data through the network link and the network traffic sampling data through the network link, wherein the scaling factor comprises a ratio of, the network traffic sampling data for a period of time multiplied by a sample ratio of the network traffic sampling data, divided by an amount of data traversing the network link for that period of time Implementations of the method may further comprise scaling, using the one or more computers, the network traffic sampling data based at least in part on the scaling factor to obtain scaled network traffic sampling data, and electronically communicating this scaled network traffic sampling data.

### BRIEF DESCRIPTION OF THE DRAWINGS

The above and related objects, features and advantages of the present invention, will be more fully understood by reference to the following detailed description of the exemplary implementations of the present invention, when taken in conjunction with the following exemplary figures, wherein:

FIG. 1 is a schematic block diagram of an exemplary system in accordance with implementations of the invention.

FIG. 2 is an exemplary flowchart in accordance with implementations of the invention.

### DETAILED DESCRIPTION OF THE PREFERRED IMPLEMENTATIONS

The present invention generally relates to a system, method and program product for obtaining IP traffic information (via NetFlow or SFlow for example) for a network, using for the network monitoring an unreliable Internet protocol (for example, with no handshaking and/or without substantial or any error checking) and that is prone to data loss (loss of packets) Implementations of the present invention compensate for missing data from the network sampling by using corresponding bandwidth data for the same network link, to scale the IP traffic information to provide a high accuracy estimation of the IP traffic.

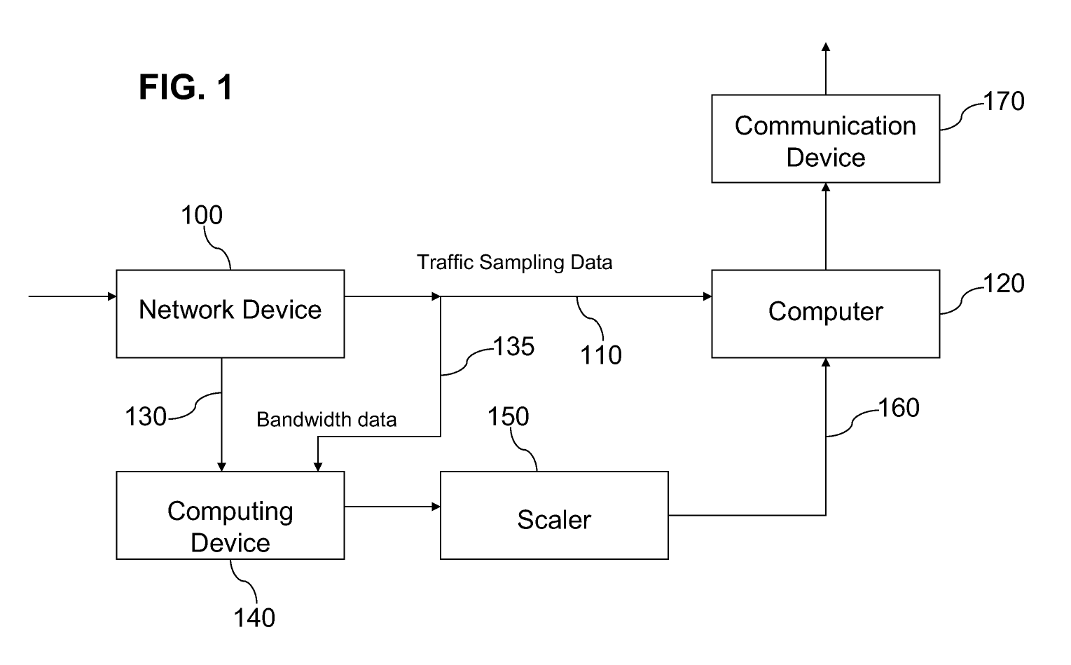

Referring to FIG. 1, an exemplary implementation of the invention is illustrated for compensating for missing data from the network sampling when lossy networks are used. In the description to follow, the system, method and program product are implemented in implementations, on one or more computers, that are configured by programming and/or hardwiring, to be capable of performing the described operations. In implementations, the one or more computers used to implement the various blocks may be distributed.

In FIG. 1, a network device 100, e.g., a router or a switch for example, obtains and provides network traffic sampling data on a lossy line 110 to a computer 120. For example, in implementations the network traffic sampling data could comprise a sampling of one packet out of every 1000 packets over a period of time, and may further include a size of the packets. In some implementations, the network traffic sampling data may be NetFlow or SFlow data. In an example, the period of time may be five minutes. Thus, if there are 4 packets received in the network traffic sampling data during the period of time, with each packet comprising 500 bytes, then a network traffic may be calculated for that line of (4 packets)×(500 bytes per packet)×(1000) per 5 minutes. The computer 120 may be configured in implementations with programming, to perform this calculation or other appropriate calculations to obtain an estimate of the network traffic on the line, e.g., bytes per time period. However, if one or more of those packets is lost due to bursty traffic on the lossy line, then the network calculation may be inaccurate.

In implementations, FIG. 1 may further comprise a computing device 140 for receiving from the network device 100 bandwidth data via line 130 for the network link. In implementations, the bandwidth data may comprise a count of a number of bytes traversing the given line during a period of time. In some implementations, the bandwidth data may comprise simple network management protocol (SNMP) data. The device 140 may also receive the traffic sampling data via line 135. In implementations, the computing device 140 may be configured to convert the received network traffic sampling data on line 135 to the same parameters as the bandwidth data on line 130 in order to make the comparison, or may receive such converted data. In some implementations, the computing device 140 may be configured to convert the bandwidth data to the same parameters as the network traffic sampling data for the comparison. In some implementations, the computing device 140 may be configured to convert the bandwidth data and the network traffic sampling data to a third set of parameters for the comparison.

In implementations, a scaler computing device 150 may be configured for determining a scaling factor, based at least in part on a comparison of the bandwidth data through the network link and the network traffic sampling data through the network link. In implementations, this scaler factor may comprise calculating a ratio of the bandwidth data to the network traffic sampling data. For example, for network traffic sampling data of (4 packets)×(500 bytes per packet)×(1000) per 5 minutes=2,000,000 bytes per 5 minutes, and bandwidth data of 3,000,000 bytes per minutes on the same line, a ratio may be calculated of 3,000,000/2,000,000=1.5. Note that this is a non-limiting example, and any other type of ratio of other factor calculation may be used to scale the network traffic sampling data to obtain a true-up.

In implementations, the computer 120 may be configured to receive the scaler factor on line 160 and perform the scaling of the network traffic sampling data. In implementations, the computer 120 may be configured to multiply the network traffic sampling data based at least in part on the scaling factor, e.g., 1.5 in the example above, to obtain scaled network traffic sampling data.

In implementations, this scaled network traffic sampling data may be sent to a communication device 170. In implementations, the communication device may comprise a display screen for displaying the scaled network traffic sampling data, and in some implementations, one or more of the bandwidth data and the scaler factor. In implementations, the communication device 170 may comprise a network device for communicating the scaled network traffic sampling data to one or more other computers.

In implementations, the computer 120 may be configured compare to the scaled network traffic sampling data for one or more periods of time to a threshold amount, and to transmit a command to change and/or to reroute network traffic, if the scaled network traffic sampling data for one or more periods of time exceeds the threshold amount.

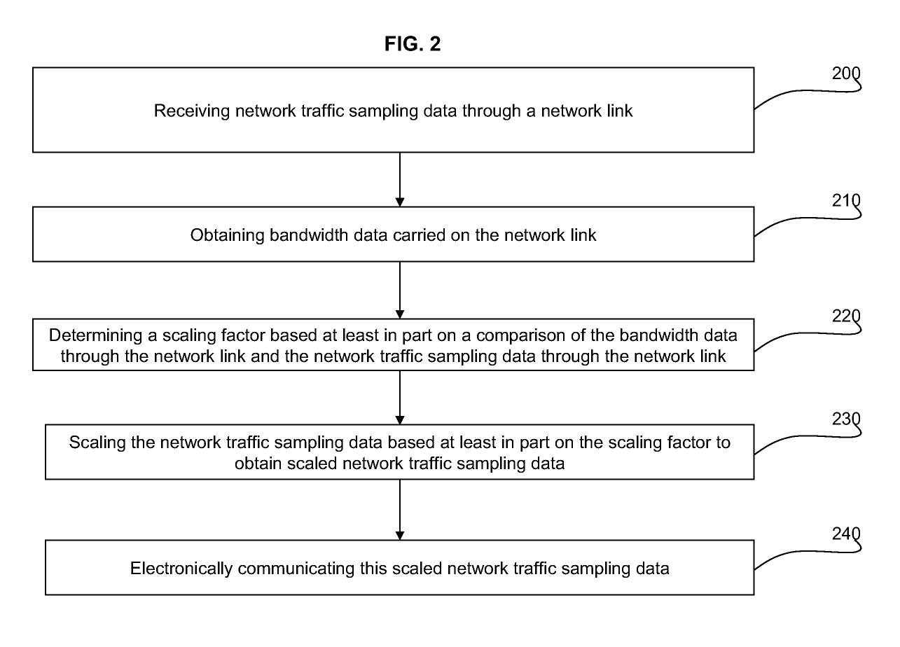

Referring to FIG. 2, implementations of a method for implementing the invention are disclosed. Block 200 comprises an operation of receiving, by one or more computers and a network link, network traffic sampling data through the network link.

Block 210 comprises an operation of obtaining, using the one or more computers, bandwidth data carried on the network link.

Block 220 comprises an operation of determining a scaling factor, using the one or more computers, based at least in part on a comparison of the bandwidth data through the network link and the network traffic sampling data through the network link.

Block 230 comprises an operation of scaling, using the one or more computers, the network traffic sampling data based at least in part on the scaling factor to obtain scaled network traffic sampling data.

Block 240 comprises an operation of electronically communicating this scaled network traffic sampling data.

The one or more computers may comprise one or more processors, that in some implementations, may be coupled with a bus, and may be configured to process and handle information and execute instructions. A main memory, such as a Random Access Memory (RAM) or other dynamic storage device, may be coupled to the bus, for storing information and instructions to be executed by the one or more processors. The main memory also may be used for storing temporary variables or other intermediate information during execution of instructions by the one or more processors. The one or more processors may be configured for executing one or more sequences of computer-readable instructions contained in the main memory. Such instructions may be read into the main memory from another computer-readable medium, such as a ROM, or other storage device. Execution of the sequences of instructions contained in the main memory will cause the one or more processors to perform the process steps described herein. It should be appreciated that implementations may perform fewer or additional processes as compared to those described herein. As noted, the one or more processors may be arranged in a multi-processing arrangement, and/or hard-wired circuitry may be used in place of or in combination with software instructions to implement the invention. Thus, implementations of the invention are not limited to any specific combination of hardware circuitry and software.

Implementations within the scope of the present invention include program products comprising machine-readable media with machine-executable instructions or data structures stored thereon. Such machine-readable media can be any available storage media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other storage medium which can be used to store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Implementations of the invention have been described in the general context of method steps which may be implemented in implementations by a program product including machine-executable instructions, such as program code, for example in the form of program modules executed by machines in networked environments. Generally, program modules include routines, programs, objects, components, data structures, etc., that perform particular tasks or implement particular data types. Multi-threaded applications may be used, for example, based on Java or C++. Machine-executable instructions, associated data structures, and program modules represent examples of program code for executing steps of the methods disclosed herein. The particular sequence of such executable instructions or associated data structures represent examples of corresponding acts for implementing the functions described in such steps.

Implementations of the present invention may be practiced with one or multiple computers in a networked environment using logical connections to one or more remote computers (including mobile devices) having processors. Logical connections may include a local area network (LAN) and a wide area network (WAN) that are presented here by way of example and not limitation. Such networked environments are commonplace in office-wide or enterprise-wide computer networks, and include intranets and the Internet, and may use a wide variety of different communication protocols. Those skilled in the art will appreciate that such network computing environments will typically encompass many types of computer system configurations, including personal computers, hand-held devices such as mobile phones and other PDA appliances, multi-processor systems, microprocessor-based or programmable consumer electronics, network PCs, minicomputers, mainframe computers, and the like. Implementations of the invention may also be practiced in distributed computing environments where tasks are performed by local and remote processing devices that are linked (either by hardwired links, wireless links, or by a combination of hardwired and wireless links) through a communications network. In a distributed computing environment, program modules may be located in both local and remote memory storage devices.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations. It should also be noted that the phrase “a plurality” is intended to mean more than one, and is not intended to refer to any previous recitation of the word “plurality,” unless preceded by the word “the.”

While this invention has been described in conjunction with the exemplary implementations outlined above, it is evident that many alternatives, modifications and variations will be apparent to those skilled in the art. Accordingly, the exemplary implementations of the invention, as set forth above, are intended to be illustrative, not limiting. Various changes may be made without departing from the spirit and scope of the invention.

We claim:

1. A method for network data flow measurement, comprising:
receiving, by one or more computers and a network link, network traffic sampling data through the network link;
obtaining, using the one or more computers, bandwidth data carried on the network link;
determining a scaling factor, using the one or more computers, based at least in part on a comparison of the bandwidth data through the network link and the network traffic sampling data through the network link;
scaling, using the one or more computers, the network traffic sampling data based at least in part on the scaling factor to obtain scaled network traffic sampling data; and
electronically communicating this scaled network traffic sampling data.

2. The method as defined in claim 1, wherein the bandwidth data comprises simple network management protocol (SNMP) data.

3. The method as defined in claim 1, wherein network traffic data comprises Netflow data or SFlow data.

4. The method as defined in claim 1, wherein the scaling factor comprises a ratio of, the network traffic sampling data for a period of time multiplied by a sample ratio of the network traffic sampling data, divided by an amount of data traversing the network link for that period of time.

5. The method as defined in claim 1, wherein the electronically communicating comprises generating data for display of the scaled network traffic sampling data on an electronic screen.

6. The method as defined in claim 1, further comprising:
transmitting, using the one or more computers, a command to change and/or reroute network traffic, if the scaled network traffic sampling data for one or more periods of time exceed a threshold amount.

7. A system for network data flow measurement, comprising:
a network connection;
one or more computers, operably connected to the network connection, the one or more computers configured to:
receive network traffic sampling data through the network link;
obtain bandwidth data carried on the network link;
determine a scaling factor based at least in part on a comparison of the bandwidth data through the network link and the network traffic sampling data through the network link;
scale the network traffic sampling data based at least in part on the scaling factor to obtain scaled network traffic sampling data; and
a transmitter configured to electronically communicate the scaled network traffic sampling data.

8. The system as defined in claim 7, wherein the bandwidth data comprises simple network management protocol (SNMP) data.

9. The system as defined in claim 7, wherein network traffic data comprises Netflow data or SFlow data.

10. The system as defined in claim 7, wherein the scaling factor comprises a ratio of, the network traffic sampling data for a period of time multiplied by a sample ratio of the network traffic sampling data, divided by an amount of data traversing the network link for that period of time.

11. The system as defined in claim 7, wherein the electronically communicating operation comprises generating data for a display the scaled network traffic sampling data on an electronic screen.

12. The system as defined in claim 7, wherein the one or more computers are further configured to:
transmit, using the one or more computers, a command to change and/or reroute network traffic, if the scaled network traffic sampling data for one or more periods of time exceed a threshold amount.

13. A method for network data flow measurement, comprising:
receiving, by one or more computers and a network link, network traffic sampling data comprising Netflow data or SFlow data through the network link;
obtaining, using the one or more computers, bandwidth data comprising simple network management protocol (SNMP) data carried on the network link;
determining a scaling factor, using the one or more computers, based at least in part on a comparison of the bandwidth data through the network link and the network traffic sampling data through the network link, wherein the scaling factor comprises a ratio of, the network traffic sampling data for a period of time multiplied by a sample ratio of the network traffic sampling data, divided by an amount of data traversing the network link for that period of time;
scaling, using the one or more computers, the network traffic sampling data based at least in part on the scaling factor to obtain scaled network traffic sampling data; and
electronically communicating this scaled network traffic sampling data.
